(19) United States
(12) Patent Application Publication
(10) Pub. No.: US 2023/0354918 A1
(43) Pub. Date: Nov. 9, 2023

(54) USER-PROFILE MODULE FOR AN AEROSOL PROVISION DEVICE

(71) Applicant: Nicoventures Trading Limited, LONDON (GB)

(72) Inventor: Zhihuang XIAO, London (GB)

(21) Appl. No.: 18/245,471

(22) PCT Filed: Sep. 15, 2021
(86) PCT No.: PCT/GB2021/052392

§ 371 Date: Mar. 15, 2023

(30) Foreign Application Priority Data
Sep. 15, 2020 (GB) 2014514.0

(51) Int. Cl. A24F 40/60; A24F 40/20; A24F 40/90; A24F 40/65; A24F 40/50

(52) U.S. Cl. CPC A24F 40/60; A24F 40/20; A24F 40/90; A24F 40/65; A24F 40/50

(57) ABSTRACT

There is provided a user-profile module for use with an aerosol provision device, the user-profile module including a housing, an internal computer memory located within the housing and a connector for operatively connecting the user-profile module to the aerosol provision device. The user-profile module can store one or more user profiles in the internal computer memory, where each user profile comprises user profile data. The user-profile module can be configured to, in use, perform at least one of copying user profile data from the one or more user profiles stored in the internal computer memory to the aerosol provision device and controlling at least one function of the aerosol provision device in dependence upon the one or more user profiles. There is also provided an aerosol provision device and a system.

### PRIORITY CLAIM

The present application is a National Phase entry of PCT Application No. PCT/GB2021/052392, filed Sep. 15, 2021, which claims priority from GB Application No. 2014514.0, filed Sep. 15, 2020, each of which hereby fully incorporated herein by reference.

### TECHNICAL FIELD

The present disclosure relates to a module for use with an aerosol provision device and a system comprising an aerosol provision device and one or more modules.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure, there is provided a user-profile module for use with an aerosol provision device, the user-profile module comprising: a housing; an internal computer memory located within the housing; and a connector for operatively connecting the user profile module to the aerosol provision device; the user-profile module being for storing one or more user profiles in the internal computer memory, wherein each user profile comprises user profile data; and the user-profile module being configured to, in use, perform at least one of: copying user profile data from the one or more user profiles stored in the internal computer memory to the aerosol provision device; and controlling at least one function of the aerosol provision device in dependence upon the one or more user profiles.

According to a second aspect of the present disclosure, there is provided an aerosol provision device comprising: a housing; an aerosol generator located within the housing; a power supply for powering the aerosol provision device; and a connector for releasably connecting the aerosol provision device to a user-profile module; wherein, in use, when the aerosol provision device is operatively connected to the user-profile module, functionality that is unavailable when the aerosol provision device is operatively disconnected from the user-profile module is activated in response to input received from the user-profile module.

According to a third aspect of the present disclosure, there is provided a system comprising an aerosol provision device and a user-profile module according to the first aspect of the present disclosure, wherein the user-profile module is operatively connected to the aerosol provision device; the operative connection being either: a direct connection to a connector of the aerosol provision device; or a connection to one or more other modules, wherein at least one of the one or more other modules is directly connected to a connector of the aerosol provision device, wherein, in use, the operatively connected user-profile module performs at least one of: copying user profile data from the one or more user profiles stored in the internal computer memory of the user-profile module to the aerosol provision device; and controlling at least one function of the aerosol provision device in dependence upon the one or more user profiles.

Further features and advantages of the disclosure will become apparent from the following description of various embodiments of the disclosure, given by way of example only, which is made with reference to the accompanying drawings.

### BRIEF DESCRIPTION OF THE DRAWINGS

FIG. 1 shows a schematic view of an example of a user-profile module.

FIG. 2 shows a schematic view of an example of an aerosol provision device.

FIG. 3 shows an example of a system including an operatively connected user-profile module and aerosol provision device.

FIG. 4 shows a schematic view of an example of an aerosol provision device.

FIG. 5 shows a schematic view of an example of a system including an operatively connected user-profile module and aerosol provision device.

FIG. 6 shows a schematic view of the system of FIG. 5, also showing a base of the user-profile module.

### DETAILED DESCRIPTION

As used herein, the term “aerosol-generating material” includes materials that provide volatilized components upon heating, typically in the form of an aerosol. Aerosol-generating material includes any tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

Apparatus is known that heats aerosol-generating material to volatilize at least one component of the aerosol-generating material, typically to form an aerosol which can be inhaled, without burning or combusting the aerosol-generating material. Such apparatus is sometimes described as an “aerosol provision device”, a “heat-not-burn device”, a “tobacco heating product device” or a “tobacco heating device” or similar. Similarly, there are also so-called e-cigarette devices, which typically vaporize an aerosol-generating material in the form of a liquid, which may or may not contain nicotine. The aerosol-generating material may be in the form of or be provided as part of a rod, cartridge or cassette or the like which can be inserted into the apparatus. An aerosol generator for volatilizing the aerosol-generating material may be provided as a “permanent” part of the apparatus, or could be combined with the aerosol-generating material in a replaceable or consumable component.

An aerosol provision device can receive an article comprising aerosol-generating material for heating. An “article” in this context is a component that includes or contains, in use, the aerosol-generating material, which is heated to volatilize the aerosol-generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article. Alternatively, aerosol-generating material can simply be located in a free or unconstrained manner in a heating chamber of a device; loose leaf tobacco, for example, could be used in this way.

As used herein, the term “operative connection” is a connection through which power and/or data may be transmitted from a module to another module and/or to an aerosol provision device. A module that is “operatively connected” to an aerosol provision device may be connected directly to the aerosol provision device, or may be directly connected to one or more other modules if at least one of the one or more other modules is directly connected to the aerosol provision device. In such an arrangement, all of the connected modules are considered to be “operatively connected” to the aerosol provision device.

As used herein, when referring to a module, the term “in use” is when the module is operatively connected to an aerosol provision device. It is not required that the aerosol provision device is also in use by a user for the purpose of generating an aerosol for inhalation for it to be considered to be operatively connected; however, this may also be the case.

As used herein, the term “controller” may mean any means by which the function of a device may be controlled. For example, a controller may comprise a simple switch configured to activate and deactivate the supply of electrical power from a power supply. Alternatively, a controller may comprise one or more microchips, which may be configured to control complex functionality in a device. A controller may be configured to allow a user direct control of the device or may be configured to control the function of a device automatically, such as in response to a user's puff, for example, or a combination thereof.

As used herein, the term “external device” refers to any device that is not an aerosol provision device or a module according to the present disclosure.

In order to improve the user experience in the use of an aerosol provision device, there is a continual drive for manufacturers to improve the functionality of the device. Aerosol provision devices typically include a very simple user interface, such as a single button interface. Even with a more complex interface, it can be difficult and time consuming for a user to configure a new device according to their personal preferences. Furthermore, even with an advanced interface such as a touch screen, it may be impossible to configure some user preferences without the use of an additional device, such as a computer or a mobile phone.

The present disclosure addresses this problem by providing a user-profile module that is connectable to an aerosol provision device. The user-profile module is configured to retain one or more user preferences and/or device usage information within an internal computer memory located within the module. In use, the user-profile module allows a user to transfer user preferences and/or device usage information between the user-profile module and an operatively connected aerosol provision device. By offering a means for transferring user preferences between the user-profile module and an aerosol provision device, the user-profile module may, for example, allow the user to quickly and simply configure a new aerosol provision device according to previously defined preferences. Such a module could, for example, allow a user to quickly and simply configure a shared aerosol provision device according to the user's preferences and/or assist with configuring a new aerosol provision device. The user-profile module could also allow a user to quickly and flexibly update user preferences on an existing aerosol provision device that they use regularly. For example, a user could configure the user-profile module such that user preferences on an operatively attached aerosol provision device are automatically updated based on factors such as the day of the week, the time in the day or the time since the device was previously connected. In another example, the module could first copy recorded usage data from an operatively connected aerosol provision device to the internal computer memory of the module, and could then update the user preferences on the device according to the usage date; for example, if the daily usage has been above normal (or perhaps above a pre-defined limit) the configured session length could be reduced. In an example of a module comprising a user interface, the user could be presented with one or more options for configuring the operatively connected aerosol provision device; such options could include preferences pre-determined by the user and/or could include preferences suggested by the module based on previous usage information.

A first aspect of the present disclosure defines a user-profile module for use with an aerosol provision device. The user-profile module comprises a housing, internal computer memory located within the housing and a connector for operatively connecting the user-profile module to an aerosol provision device. The connector is configured in any way that allows for an operative connection to be formed between the user-profile module and an aerosol provision device. The user-profile module is configured to store one or more user profiles in the internal computer memory, wherein each user profile comprises user profile data. In use, the user-profile module is configured to perform at least one of: copying user profile data from the one or more user profiles stored in the internal computer memory to the aerosol provision device; and controlling at least one function of the aerosol provision device in dependence upon the one or more user profiles. Copying the user profile data to the aerosol provision device is beneficial because it may allow for the aerosol provision device to operate according to the copied user profile data without any specific instruction or control from the user-profile module. Furthermore, the aerosol provision device may be able to retain the copied user profile data for future use. By directly controlling at least one function of the aerosol provision device via the user-profile module, the aerosol provision device may be able to operate according to the user profile data even in examples where the aerosol provision device is not able to be configured by the user-profile module. In such examples, the user-profile module may provide the aerosol provision device, in use, with explicit instructions for operation, such as timing sequences and other operating protocols, following information stored in the one or more user profiles. This may allow for an aerosol provision device to operate according to user-defined preferences, even when the aerosol provision device is not separately configurable by a user.

Forming an operative connection may involve a physical engagement between the connector of the module and a connector of either another module or an aerosol provision device. Such a physical connection may be achieved by the module comprising one or both of a male or female portion of a connector such as a USB Type C connector. Alternatively, the physical engagement may be achieved through a genderless connection. A physical connection has the advantage of improved reliability, and simple design. It additionally provides an opportunity for tactile feedback for users, in that a user can feel and/or see when a physical connection has been made between the module(s) and the aerosol provision device.

The connector may also be configured such that physical engagement is not necessary. An operative connection could be achieved, for example, through the use of a wireless data and/or power connection. The module may additionally be secured to another module and/or an aerosol provision device using, for example, magnetic attraction. Non-physical connections have the advantage that external connectors may not be necessary, reducing the risk of damage to the connectors during the lifetime of the devices and simplifying the design of the housing for both the module and the aerosol provision device. Whilst the additional securing of the module to another module and/or an aerosol provision device is not essential, it can assist in ensuring that the non-physical operable connection between the relevant components is reliable due to the retention of contact between the module and the relevant component.

A further alternative could be to use a physical engagement to secure the devices together, while the operative connection (i.e. the data and/or power connection) is achieved wirelessly. Such a physical engagement could be achieved, for example, by an interference fit between components, or through external engagement members. A physical engagement has the advantage that the user can more easily determine whether a connection has been made between the components, for example, through a tactile signal or simply by being able to visually perceive or feel that the connection has been made. A wireless operative connection avoids using power and/or data connections on the housing, thus simplifying the design and manufacturing requirements of the housing.

According to a first aspect of the present disclosure, the user-profile module is configured such that, in use, the user-profile module is operatively connected to an aerosol provision device. The user-profile module is able to store one or more user profiles in its internal memory, a user profile containing one or more user preferences or pieces of information about a user. In use, the user-profile module is able to transfer data between the user-profile module and the operatively connected aerosol provision device. The user-profile module may, for example, allow a user to copy user profile information and/or usage information from the operatively connected aerosol provision device. Alternatively, or additionally, the user-profile module may allow the user to copy previously defined user preferences to the operatively connected aerosol provision device. This has the advantage of allowing the user to quickly and easily transfer data between an aerosol provision device and a user-profile module, for example to configure a new or existing aerosol provision device according to previously defined user preferences. Such a module could, for example, allow the user to quickly and easily update user preferences in an operatively connected aerosol provision device without needing a complex user interface, or an additional device such as a mobile phone or a computer.

Examples of specific functionality that may be included in an example of a user-profile module according to the first aspect of the present disclosure are discussed in more detail below. It should be understood that unless explicitly stated otherwise, any of the following examples may be combined in a module according to the first aspect of the present disclosure.

In some examples, the user profile data stored in the internal computer memory of the user-profile module consists of one or more user preferences and/or usage information. User preferences may be, for example, one or more configuration preferences for an aerosol provision device. This may allow for user configuration preferences to be stored for later use in the configuration or operation of an operatively connected aerosol provision device. Usage data may comprise, for example, information regarding the historical usage of one or more aerosol provision devices by a user. Storing such information may allow for the usage data to be analyzed by the user, for example in order to modify user preferences or device usage in futures sessions. Each of these types of user profile data are discussed in more detail below.

The user-profile module may be configured such that, in use, the user-profile module is able to configure an operatively connected aerosol provision device with one or more user preferences, as defined in one or more user profiles. This has the advantage that an operatively connected aerosol provision device may be quickly and easily configured according to the user's previously defined user preferences. For example, the user may configure the user preferences stored on the user-profile module using an external device, such as a computer, and then later use the user-profile module to quickly configure a new or regularly used aerosol provision device, or perhaps an aerosol provision device borrowed from a friend, according to the user preferences stored in the user-profile module.

A user-profile module may be configured such that, in use, the user-profile module is able to copy data from an operatively connected aerosol provision device, the copied data being stored in the internal computer memory of the user-profile module. This has the advantage of allowing the user to copy data from an aerosol provision device without the need for an additional device. This could, for example, avoid the user being required to use a device such as a computer or a smartphone in order to extract and/or review data stored in an aerosol provision device.

In an example of a user-profile module configured to be able to copy data from an operatively connected aerosol provision device, the data that is copied to the internal computer storage of the user-profile module comprises one or more user preferences. Allowing previously defined user preferences to be copied from an aerosol provision device to the internal memory of a user-profile module may assist the user in configuring the aerosol provision device according to the user's preferences in the future. Also, such a module may allow for the user to more easily review the user preferences linked to the aerosol provision device. For example, the aerosol provision device may not have a sophisticated user interface and may be unable to connect directly with an external device; the user-profile module could allow for the user to review the user preferences either directly or through the use of an external device.

In an example of a user-profile module configured to be able to copy data from an operatively connected aerosol provision device, where the data that is copied to the internal computer storage of the user-profile module comprises more than one set of user preferences, the sets of user preferences are stored as individual user profiles in the internal computer memory of the user-profile module. This has the advantage that the user is able to store multiple different profiles in the user-profile module. For example, different user profiles may be configured for use with different aerosol provision devices or different aerosol-generating materials. It is also feasible for different user profiles to be used on a single aerosol provision device, i.e. different users could each have a profile that could be implemented on a common aerosol provision device.

In an example of a user-profile module configured to be able to copy data from an operatively connected aerosol provision device, the data that is copied to the internal memory of the user-profile module comprises usage data for the aerosol provision device. Such usage data may comprise, for example, information regarding: the length of smoking sessions, the number of puffs taken, the length of each puff, the heating profile used for each session, the type of consumable article used, the amount of electrical power used in each session, the amount by which an internal power supply of the aerosol provision device was depleted by each session. This may allow the user to review the usage data. Allowing the user to review the usage data may allow for the user to adjust aspects of their device usage. For example, reviewing the data may indicate that it would be beneficial to increase or reduce the draw time in each puff in order to improve the user experience. Alternatively, or additionally, copying usage information from an aerosol provision device to an operatively connected user-profile module may allow for the module to automatically update user preferences in the aerosol provision device based on the copied usage information. For example, if the usage information indicates that the aerosol provision device has been used heavily during a given period (for example, during the day in which the module is connected), the module could reduce the configured session time in the aerosol provision device. In a further example, if the aerosol provision device comprises a means for providing the user with feedback (for example an LED indicator), the module could configure the aerosol provision device to alert the user about the previous heavy usage upon commencement of a subsequent session.

A user-profile module may be configured such that, in use, it is able to identify one or more properties of an operatively connected aerosol provision device. This has the advantage that the user-profile module may be able to determine, from the one or more identified properties, what type of aerosol provision device is operatively attached. Furthermore, the one or more identified properties may allow the user-profile module to recognize when the operatively connected aerosol provision device is an aerosol provision device that has previously been operatively connected to the module. This may be advantageous, for example, in order to prevent a module from transferring data between an aerosol provision device and the module when such data has previously been transferred.

In an example of a user-profile module that is configured such that, in use, it is able to identify one or more properties of an operatively connected aerosol provision device, the user-profile module is configured to selectively transfer user preferences between the module and the aerosol provision device based on the identified properties of the aerosol provision device. This is advantageous as it may allow the user to configure the module to transfer specific user preferences between specific aerosol provision devices and the module. For example, if, in use, the module identifies that the operatively connected aerosol provision device is capable of operating in a higher power mode (i.e. a mode where an increased amount of electrical power is provided to the aerosol generator), specific user preferences relating to high power operation of an aerosol provision device may be transferred. Alternatively, the module may identify that the aerosol provision device is in a particular category of aerosol provision devices, such as a vaping device or a tobacco heating product.

A user-profile module may be configured such that the internal computer memory is non-volatile computer memory. This has the advantage that data stored in the internal computer memory would be retained in circumstances where no electrical power is provided to the internal computer memory.

The user-profile module may contain an internal power supply. This has the advantage that, in use, the module would not require power to be supplied from another operatively connected device. In a situation where the user-profile module is operatively connected only to an aerosol provision device, this would allow the user-profile module to be used without depleting an internal power supply of the aerosol provision device. This is advantageous because it would mean that use of the user-profile module would not reduce the electrical power available for operation of the aerosol provision device.

The internal power supply of the user-profile module may be a rechargeable battery or a capacitor. A rechargeable battery may be any suitable rechargeable battery; examples of suitable batteries include lithium-ion and nickel cadmium type batteries. Rechargeable power supplies such as rechargeable batteries and capacitors are advantageous as they can be easily recharged when depleted and can undergo a large number of charge-discharge cycles before needing to be replaced.

The internal power supply of a user-profile module may be configured to supply power to an operatively connected aerosol provision device or another connected module. This has the advantage that, in use, the user-profile module could recharge an internal power supply of the operatively connected aerosol provision device or module. A further advantage is that, in use, the operatively connected aerosol provision device could be provided without an internal power supply, further reducing the size, weight and complexity of the aerosol provision device.

The user-profile module may contain means for wireless transmission of electrical power. This may comprise means for receiving electrical power from an external supply, such as from an external wireless charging pad. Alternatively, or in addition, the means for wireless power transmission may be configured to transmit electrical power to a further device, external to the housing of the user-profile module. The further device may be another module, an aerosol provision device or an external device configured to receive electrical power wirelessly. The user-profile module may comprise more than one means for wireless transmission of electrical power, such that the user-profile module may transfer electrical power to or from more than one device simultaneously. Transmitting electrical power wirelessly is advantageous because it may avoid the need for a physical connector to be located on the user-profile module housing. This would simplify the design and manufacturing requirements for the user-profile module housing and may also improve the safety and ease of use of the user-profile module. Furthermore, a module comprising means for transmitting and/or receiving electrical power wirelessly would allow for such functionality to be added to an operatively connected aerosol provision device, without the adding to the size, weight or cost of the aerosol provision device.

The user-profile module may contain means for physical connection to an external device. The physical connection may allow for electrical power to be supplied by the user-profile module to an external device or to the user-profile module from an external device. The external device may be, for example, a plug connected to a wall socket, a back-up power supply, such as a battery or another energy storage device, a mobile phone, a tablet or a computer. This could allow for a user to interact with the user-profile module without it being operatively connected to an aerosol provision device, for example, to adjust pre-set user preferences.

In an example where the user-profile module is connected to an external source of electrical power, the supplied external power may be directed to charge at least one of: a power supply located within the user-profile module, i.e. an internal power supply; a power supply located within a further operatively connected module; and a power supply located within an operatively connected aerosol provision device, by means of a controller. The user-profile module may be configured such that the controller determines the amount of power being supplied to the module. The user-profile module may be further configured such that if the controller determines that the power supplied is insufficient to charge one or more of: the internal power supply of the user-profile module; the power supply of the operatively connected module; and the power supply located within the operatively connected aerosol provision device, the controller may preferentially direct the supplied power accordingly. The order in which the one or more power supplies should preferentially be charged may be pre-set or may be configurable by the user. It may be preferable for the power supply of an operatively connected aerosol provision device to be charged before any other power supplies, for example. The user-profile module may be further configured such that if the externally supplied power is insufficient to charge the internal power supply of the user-profile module, or any of the power supplies to which the user-profile module is operatively connected, the electrical power is not supplied to any of the power supplies. The user-profile module may also be configured to alert the user that the externally provided power supply is insufficient to charge one or more of the power supplies; the alert may be a visual, audible and/or tactile indication. The user-profile module may be additionally configured such that when an external power supply is connected, the user-profile module indicates to the user which, if any, of the operatively connected power supplies is being charged.

A user-profile module may comprise a user interface. This has the advantage of allowing the user to interact directly with the user-profile module. This may, for example, allow for the user to configure data stored within the internal computer memory of the user-profile module, without the need for an additional external device.

In an example of a user-profile module a user interface; the user interface is configured to provide the user with information. The means for providing information could be, for example, visual, through the use of one or more LEDs, lights, LCD screens; audible, through the use of one or more loudspeakers, clickers, buzzers; or tactile, through the use of a vibrator. It should be understood that these are merely examples of possible means for providing the user with information; the examples given could be used in any combination and should not be considered an exhaustive list of possibilities. This has the advantage of providing the user with information without requiring an external device. Such information could comprise, for example, information regarding data stored in the internal computer memory. In an example where the user-profile module comprises an internal power supply, the means for providing the user with information could, for example, inform the user how much electrical power remains in the internal power supply.

In a further example of a user-profile module comprising a user interface; the user interface alternatively, or additionally, is configured to receive user input. The means for receiving user input could comprise one or more buttons, switches, dials and/or rolling buttons. In an example where the user-profile module is also configured to provide the user with information, the means for providing information and the means for receiving user input could be combined. An example of such a combined user interface is a touchscreen. Providing the user with means for receiving user input (whether combined with means for displaying information, or not) could allow the user to interact with the module, for example to configure user preferences, without needing an external device.

In a further example of a user-profile module comprising a user interface; the module, in use, allows a user to interact with one or more of: the user-profile module, an operatively connected aerosol provision device, another operatively connected module. This has the advantage of allowing the user to interact with one or more of the operatively connected devices, without the need for an external device. For example, a user-profile module comprising means for providing the user with information could provide the user with information regarding the remaining power in an internal power supply of an operatively connected aerosol provision device. In another example, a user-profile module comprising means for receiving user input could allow the user to control the functionality of an operatively connected aerosol provision device. In a further example, a user-profile module comprising a combined means for displaying information and receiving input, such as a touchscreen, could allow the user to review and configure user preferences stored in the user-profile module, or in another operatively connected device (such as an aerosol provision module). These examples could each offer an improved user experience.

A user-profile module may be configured to communicate with an external device, and the means for communicating may be configured such that data transfer can take place. Such a means for communication may comprise, for example, a standard data connector such as USB Type C connector. The data connection may allow for data to be exchanged with the external device. Such data could comprise, for example, user-specified configurations for the user-profile module and/or the operatively connected aerosol provision device. The data transfer may also allow for the user-profile module to be configured according to the preferences of the user using the external device. An external device may be, for example, a mobile phone, a tablet, a computer etc.

In an example of a user-profile module configured to communicate with an external device; the means for communication is wireless. The means for wireless communication may use one or more wireless communication protocols. Examples of possible wireless communication protocols could be Bluetooth™, Wi-Fi™, cellular network communication etc. Wireless communication with an external device could allow for data transfer between the user-profile module and the external device. Such data could, for example, comprise user specified configurations for the user-profile module and/or the operatively connected aerosol provision device. The data stored may also comprise usage data recorded by the aerosol provision device; such data could be used, for example, to automatically order more consumable articles when needed. The data transfer may also allow for the user-profile module to be configured according to the preferences of the user by means of the external device. An external device may be, for example, a mobile phone, a tablet, a computer etc.

As previously noted, it will be appreciated that several of the examples discussed above could be combined with one another. For example, a user-profile module could include one or more means for user interaction, as discussed above, as well as a power supply and/or means for communicating with an external device. Whilst the possible module capabilities have been set out separately in some cases, their combination is not precluded within a single module.

According to a second aspect of the present disclosure, there is provided an aerosol provision device. The device comprises: a housing; an aerosol generator located within the housing; and a connector, wherein the connector is configured to form a releasable operative connection to a user-profile module according to one or more examples of the first aspect of the disclosure, as described above. The aerosol provision device also comprises an internal power supply configured to supply power to the aerosol generator, which has the advantage of allowing the aerosol provision device to operate even when a module is not operatively connected to the device. In examples where the aerosol provision device comprises a limited internal power supply, supplementary electrical power may be supplied to the aerosol provision device, for example in order for its aerosol generator to function in a higher power mode. Such electrical power may be provided by an operatively connected module, or by an external power supply. Examples in which the aerosol provision device comprises a limited internal power supply may be advantageous as the size, weight and/or complexity of the aerosol provision device may be reduced. In some examples, the device also contains internal computer memory. In such devices, user defined preferences and/or usage information may be stored in the internal computer memory. In use, stored information may be transferred to and/or from an operatively connected user-profile module. In some examples of an aerosol provision device that does not comprise internal computer memory, user preferences applied to the device by the operatively connected user-profile module may only be retained while the user-profile module is operatively connected; upon disconnection of the user-profile module the aerosol provision device may revert to a default configuration.

According to a third aspect of the present disclosure, there is provided a system comprising an aerosol provision device and a user-profile module, wherein the user-profile module is operatively connected to the aerosol provision device; the operative connection being either: a direct connection to a connector of the aerosol provision device; or a connection to one or more other modules, wherein at least one of the one or more other modules is directly connected to a connector of the aerosol provision device. In use, the operatively connected user-profile module performs at least one of: copying user profile data from the one or more user profiles stored in the internal computer memory of the user-profile module to the aerosol provision device; and controlling at least one function of the aerosol provision device in dependence upon the one or more user profiles.

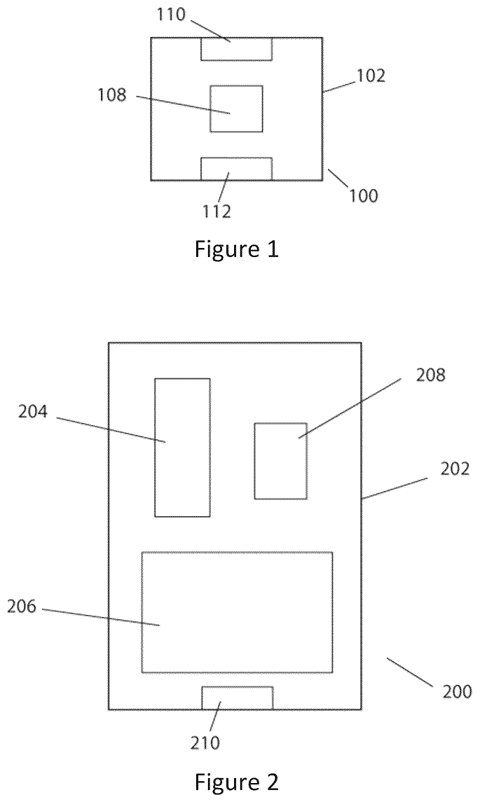

Referring to FIG. 1, a user-profile module 100 for use with an aerosol provision device is schematically illustrated. The user-profile module 100 comprises: a housing 100; internal computer memory 108 located within the housing 102 and a connector 110, the connector being configured to interact with either an aerosol provision device or another module. In some embodiments, the user-profile module 100 may comprise a second connector 112 (as shown in FIG. 1) and possibly further connectors (not shown). Each of the second and further connectors is configured to interact with either an aerosol provision device or a further module.

The housing 102 of the user-profile module 100 may be composed from any suitable material. A metallic material such as steel or aluminum may be used; stainless steel and aluminum are inexpensive, and easy to manufacture and offer good corrosion resistance. A housing comprising a metallic material may also offer improved dissipation of any heat generated within the device, increasing user comfort during use, and may be more aesthetically pleasing than alternative options. Electrically conductive materials may be used; a housing composed from an electrically conductive material may additionally function as an antenna to facilitate or improve wireless communication, in examples where the module comprises means for wireless communication, as described in more detail below. Alternatively, the housing may be made from plastic. Plastic is inexpensive, it can be easily formed into any desired shape and is not electrically conductive, which may help to improve the safety of the device. Examples of suitable plastic materials could be polycarbonate (PC), acrylonitrile butadiene styrene (ABS) or a combination of PC and ABS; PC and ABS are strong, tough, inexpensive and can be easily formed into any required shape. PC and ABS can also both be easily colored and decorated both within the structure of the plastic material and with surface paints; this allows for the housing 102 to be easily decorated. Furthermore, a plastic material may beneficially allow for a discrete antenna to be embedded with the plastic material of the housing or printed onto the outer and/or inner surface of the housing 102 in order to facilitate or improve wireless communication, in examples where the module comprises means for wireless communication, as described in more detail below. The housing 102 may be configured to be changeable, allowing for at least part of the housing 102 to be replaced by the user, for example to change its appearance.

The user-profile module 100 comprises at least one connector 110, the connector 110 being configured to connect to the connector of another module or an aerosol provision device. When connected to the connector of another device, the connector 110 of the user-profile module and the connector of the other device may be referred to as ‘a pair of connectors’.

In some examples, the first connector 110 and any further connectors are configured in such a way that an operative connection is formed with another module or with an aerosol provision device without physical engagement of the pair of connectors. If the housing 102 does not have any openings, it could be water resistant in that the housing material is resistant to water and the lack of openings in the housing prevents water ingress into the internal components of the user-profile module. A means for securing the user-profile module 100 to at least one second device (a second device being another module or an aerosol provision device) without physical engagement of the pair of connectors can additionally be provided. In one example, the user-profile module 100 comprises at least one magnet (or a portion of magnetic material) arranged such that when the second device also comprises at least one magnet, the at least one magnet of the user-profile module and the at least one magnet of the second device secure the devices relative to one another by magnetic attraction. In this example, the one or more magnets are positioned such that the magnetic attraction between the magnet(s) of the module 100 and the magnet(s) of the second device cause the user-profile module 100 and the second device to be aligned in a manner that allows for the pair of connectors to be operatively connected. This type of alignment is particularly useful where the operative connection between the pair of connectors is a wireless one and there is, therefore, no additional physical engagement of the components.

In another example, the housing 102 of the user-profile module 100 may be configured such that when the user-profile module 100 is connected to a second device, the housing 102 secures the user-profile module 100 to the second device by an interference fit. Such an arrangement could be achieved, for example, by configuring the housing 102 of the user-profile module 100 such that the housing 102 is configured to at least partially surround or enclose the second device, or vice versa. Other types of physical engagements between the user-profile module 100 and the second device are also possible, for example a screw or bayonet type connection, whereby a portion of the module housing 102 comprises a screw or bayonet type fitting to be inserted into a corresponding connector and twisted in order to form a secure engagement (or vice versa). The housing 102 could also comprise one or more movable engagement members, such as a latch or a spring-loaded button, or means to engage with such a moveable member of a second device, in order to improve the security of engagement with a second device. Physical engagement of this kind has the benefit that the user will have a tactile indication as to the security of the engagement.

In some examples, the pair of connectors is configured to be physically engaged in order to be operatively connected. In these examples, the housing 102 of the user-profile module 100 comprises one or more openings to facilitate connection with other devices. In one example, the first connector 110 and the second connector 112 are each arranged adjacent to an opening in the housing 102, such that each of the connectors can physically engage with a connector of another device when it is placed inside, or at least adjacent to, the respective opening in the housing 102.

In examples where the pair of connectors are physically engaged to make an operative connection, at least one of the connectors may comprise a ‘male’ portion, configured to be inserted into the ‘female’ portion of the corresponding connector. It is also possible that each connector comprises both a male and a female portion, such that any connector may be connected to any other connector. However, it is preferable that the connectors comprise only male or female portions, such that, in use, the number of male connector portions not connected to a female connector (i.e. non-connected male connectors) is minimized. The male portion of a connector must, by definition, extend outwards. Therefore, when the user-profile module is in use, a non-connected male connector is more likely to be accidentally damaged than a non-connected female connector. Furthermore, when a module is in use, a non-connected male connector could possibly cause damage to external objects, or discomfort to the user.

In one example, the first connector 110 of the user-profile module 100 is the only male connector of the module 100. The user-profile module 100 may comprise one or more additional female connectors, into which the male portion of a connector of another module or an aerosol provision device may be inserted. The user-profile module may be prevented from operating unless the first connector 110 is connected to another device (either another module or an aerosol provision device). Therefore, if the first connector 110 of the user-profile module 100 is connected to another device, it may be understood that, in use, a system comprising one or more such modules 100, operatively connected to an aerosol provision device, will have no modules comprising a non-connected male connector.

In one example, the user-profile module 100 comprises only a first connector 110, and no further connectors. A module according to this example may be connected to only one of: another module; or an aerosol provision device. A user-profile module 100 comprising only a first connector 110 offers a simplified design and easy manufacturing of the user-profile module. In such a module, it may be advantageous for the first connector 110 to be a male type connector.

The user-profile module 100 may comprise means for connecting to an external device (other than an aerosol provision device or another module), herein referred to as an ‘external connector’ (not shown in the figures). An external connector configured to form a physical connection with an external device may be a commercially available connector such as a USB Type-C, or a proprietary connector. An external connector may alternatively be a wireless external connector, configured to connect wirelessly to an external device. A wireless external connector may use, for example, Bluetooth™, Wi-Fi™, NFC or a cellular network connection. The external connector may allow for the module 100 to receive electrical power from an external device. The external connector may additionally or alternatively allow for the exchange of data between the module 100 and the external device. Such data may, for example, comprise user specified configurations for the user-profile module and/or the operatively connected aerosol provision device.

Referring to FIG. 2, an aerosol provision device 200 is schematically illustrated. The aerosol provision device 200 comprises: a housing 202 (which may also be referred to as the ‘outer cover’); and an aerosol generator in the form of a heater 204 located within the housing 202; internal computer memory 208 located within the housing 202; and a connector 210 configured to interact with a module. The aerosol provision device may further comprise a power supply 206 located within the housing 202. The aerosol provision device 200 may be configured to function independently when not connected to any additional modules; in such examples the internal power supply 206 is present. The aerosol provision device 200 may comprise a puff sensor (not shown in the figures), configured to detect when a user is drawing on the aerosol provision device 200. The internal computer memory 208 is configured to store data, such data may comprise user defined preferences. The data stored by the internal computer memory 208 may also comprise usage data for the aerosol provision device 200, such usage data may be recorded while the aerosol provision device 200 is in use by a user.

As previously discussed, a user-profile module 100 allows a user to transfer data between the user-profile module 100 and an operatively connected aerosol provision device 200. Some example situations in which a user may wish to make use of this functionality are outlined below, along with possible configurations of a user-profile module 100 that could assist with these situations. It should be understood that these examples are merely intended to illustrate ways in which the user-profile module 100 could be configured in order to solve the technical problem of transferring data to and/or from an aerosol provision device 200; these examples should not be considered to be an exhaustive list of possible enhanced functionalities which can be provided by the user-profile module 100.

In one example of a user-profile module 100, a user is able to use the user-profile module 100 in order to copy user preferences from an operatively connected aerosol provision device 200. In this situation, the aerosol provision device 200 would have previously been configured with one or more user preferences. The module 100 may be configured to automatically copy user preferences from an operatively connected aerosol provision device 200 upon connection. Alternatively, in an example of a module 100 with a user interface configured to receive user input, the module may be configured to await user instructions before copying user preferences from an operatively connected aerosol provision device 200.

The user preferences stored in the internal memory 208 of the aerosol provision device 200 may include, for example, one or more custom heating profiles. In an example where the aerosol provision device 200 comprises a user interface or is connectable to an external device, the user may have configured the user interface according to their preference. For example, if the aerosol provision device 200 comprises one or more LEDs, the user may configure preferred colors to be displayed in certain situations; such colors may be used to report information regarding the aerosol provision device to the user. In an example where the aerosol provision device comprises a user interface configured to provide the user with audible or visual feedback in the form of language, the user may configure the aerosol provision device to use the user's preferred language. In an example where the aerosol provision device 200 comprises a puff sensor, the aerosol provision device 200 may be configured to provide the user with feedback (visual, audible and/or tactile) in order to optimize the user's puffing regime; for example, during a puff the user may be provided with feedback when it is the optimal time to end the puff, according to a user specified optimal puffing regime.

The copied set of user preferences can be stored in the internal computer memory 108 of the user-profile module 100 in one or more user profiles. A particular user profile may be configured by the user in order to contain specific preferences and could be one of a set of user profiles. The user-profile module 100 may be configured to identify one or more properties of the operatively connected aerosol provision device 200. By identifying the one or more properties, the module may be able to identify a specific aerosol provision device 200 and thus copy the user preferences stored in the internal memory 208 of the aerosol provision device 200 to a specific user profile associated with the identified aerosol provision device 200. For example, the module 100 may recognize that an operatively connected aerosol provision device 200 has previously been connected to the module 100 and may implement the user preferences from a user profile already associated with the device 200 and/or copy user preferences from the aerosol provision device 200 to the existing user profile stored in the user-profile module for that device. Alternatively, if the module 100 does not recognize the operatively connected aerosol provision device 200, the user preferences may be copied to a new user profile in the memory of the module 100. The new user profile could be associated with the operatively connected aerosol provision device 200 such that if connected again at a later time, the module 100 could recognize the device 200 and copy the user preferences to the associated user profile or implement the previously stored user preferences.

In some examples, the module 100 is configurable by the user to follow a pre-set program when connected to an aerosol provision device 200. For example, the user could configure the module 100 such that if a previously unknown aerosol provision device 200 is operatively connected, pre-set user preferences are copied to the device 200. In another example, if the module 100 is operatively connected to a device 200 that has previously been connected (i.e. a ‘known device’), the module 100 may be configured to copy user preferences to the device 200 from a user profile stored in the memory of the module 100 that is associated with the known device 200. Alternatively, the module 100 may be configured such that when the module 100 is connected to a known device 200, the user preferences configured in the device 200 are compared with the user preferences stored in the memory of the module 100 in a profile associated with the device 200, and any differences are updated in the memory of the module 100 to match those configured on the device 200.

In a further example where the module 100 comprises a user interface, when the module 100 is connected to a device 200, the module 100 may offer the user a choice of options: user preferences stored in a profile in the internal memory of the module 100 may be copied to the device and/or any user preferences configured on the device 200 may be copied to a profile stored in the memory of the module 100. In an example where the module 100 is connected to a known device 200, the module may compare the user preferences stored in the module 100 in a profile associated with the device 200 with any user preferences configured on the device 200; the user may then be presented with an option as to which of these preferences should be updated.

The use of the user-profile module 100 would be advantageous if, for example, the user wished to discard the aerosol provision device 200, while preserving the user configured preferences for that device. This would also be advantageous if the user wished to ensure that, in the case of loss or damage to the aerosol provision device 200, the user defined preferences were preserved. Additionally, the user-profile module 100 would be advantageous in allowing for the user to quickly and flexibly update user preferences on an existing aerosol provision device 200 according to one or more user profiles stored in the internal memory of the module 100.

In another example, the user-profile module 100 is used to configure an operatively connected aerosol provision device 200 according to user preferences stored in the internal computer memory 108 of the module 100. The module 100 may be configured to automatically copy user preferences to an operatively connected aerosol provision device 200. Alternatively, in an example of a module 100 comprising a user interface configured to receive user input, the module may be configured to await user instructions before copying user preferences to an operatively connected aerosol provision device 200. The user-profile module 100 may be configured to identify one or more properties of the operatively connected aerosol provision device 200. By identifying the one or more properties, the module may be able to identify a specific aerosol provision device 200 and thus copy specific user preferences stored in the internal memory 108 of the user-profile module 100 to the aerosol provision device 200. For example, the module 100 may recognize that an operatively connected aerosol provision device 200 has previously been connected to the module 100 and may copy the user preferences from a user profile already associated with the device 200. Alternatively, if the module 100 does not recognize the specific operatively connected aerosol provision device 200, the properties of the aerosol provision device 200 identified by the module 100 may be sufficient for the module 100 to select appropriate user preferences to copy to the device 200. For example, if the module identifies that the aerosol provision device 200 is capable of operating in a high-power mode (i.e. a mode where increased electrical power is provided to the aerosol generator), the module 100 may copy to the device 200 specific heating profiles configured by the user to be used by a device configured to operate in a high-power mode. In another example, if the user-profile module 100 identifies that the operatively connected aerosol provision device is capable of providing the user with audible and/or visual feedback in the form of language, the module 100 may configure the device 200 to use a user specified language.

This could advantageously allow a user to quickly and easily configure a new aerosol provision device 200 according to previously defined preferences. For example, if the user were to purchase a new aerosol provision device 200, the user could use the user-profile module 100 to copy the user preferences from an old device, and then configure the new device 200 according to the copied preferences. An aerosol provision device 200 could also be shared by more than one user; for example each user could have their own user-profile module 100 or a specific profile stored with other user profiles on a single user-profile module, which would allow them to quickly and easily configure the shared aerosol provision device 200 according to their preferences whenever they wished to use the device 200.

In another example, the user-profile module 100 is able to both copy user preferences from an operatively connected aerosol provision device 200 and configure an operatively connected aerosol provision device 200 with user preferences stored in the internal computer memory 108 of the module 100. As discussed above, in an example where the user-profile module 100 comprises a user interface, the user may indicate, upon operatively connecting an aerosol provision device 200, whether the module 100 should copy user preferences from the device 200, or whether the device 200 should be configured with user preferences stored in the internal computer memory 108 of the module 100. The user may indicate that any user preferences stored on the device 200 should first be copied into the internal memory 108 of the module 100, and subsequently that the device 200 should be configured according to user preferences previously stored in the internal computer memory 108 of the module 100 (i.e. preferences other than those copied from the device 200).

This would allow for a user to use the user-profile module 100 to configure an aerosol provision device with user preferences, while retaining a copy of the previously defined user preferences of the device within the internal computer memory of the module 100. This could be beneficial, for example, if a user were to borrow an aerosol provision device 200. In such a situation, the user-profile module 100 could be used as follows: the module could first copy any user preferences already configured in the aerosol provision device, the module could then configure the aerosol provision device according to the user preferences defined by the user of the user-profile module 100 (this would be assumed to overwrite any conflicting user preferences stored in the internal computer memory 208 of the aerosol provision device 200); after the user has finished using the aerosol provision device 200 the user-profile module 100 could then be used to restore the original user preferences to the device 200 (the preferences having been stored in the internal computer memory of the user-profile module 100). The copying and subsequent restoration of user preferences to the aerosol provision device 200 could be configured to happen automatically at the beginning and end of a session when the module 100 is connected to an aerosol provision device 200 that already has user preferences configured. Alternatively, in an example where the user-profile module 100 comprises a user interface, the user may be presented with an option to confirm that user preferences should be updated and/or the previously configured user preferences restored to the aerosol provision device 200. Such use of the user-profile module 100 could allow for a user to configure a borrowed aerosol provision device 200 according to their preferences, and then to return the configuration of the device 200 to its previous state after the user had finished the session.

The user-profile module 100 may be configured by the user such that when the module 100 is operatively connected to an aerosol provision device 200, one of the following actions are automatically performed: the aerosol provision device 200 is configured according to user preferences stored within the internal computer memory 108 of the module 100, user preferences are copied from the device 200 to the memory 108 of the module 100, user preferences are copied from the device 200 to the memory 108 of the module 100 and then the device 200 is configured according to alternative user preferences also stored within the memory 108 of the module 100. Allowing the user to specify a preferred action would allow for the desired process to be performed more quickly and simply by the user-profile module 100 upon connection to an aerosol provision device 200. Allowing the user to specify a preferred action would be beneficial in a user-profile module 100 that does not comprise a user interface. In such a user-profile module 100, the configuration of preferred actions may be performed though an external device. Such a device may be, for example, a computer or a smartphone.

The user-profile module 100 is able to copy data other than user preferences from an operatively connected aerosol provision device 200 to the internal computer memory 108 of the module 100. Such data may comprise, for example, usage data stored by the aerosol provision device. Such usage data could comprise, for example, one or more of: the length of smoking sessions, the number of puffs taken, the length of each puff, the heating profile used for each session, the type of consumable article used, the amount of electrical power used in each session, the amount by which an internal power supply of the aerosol provision device was depleted by each session. This usage data, once stored in the internal memory of the user-profile module, could be reviewed by the user through the use of an external device, such as a computer or a smartphone. In an example of a module 100 comprising a user interface configured to provide the user with information, the user may additionally, or alternatively, be able to review the usage data directly using the module 100. The usage data could also be used by the user-profile module 100 to automatically order additional consumable articles when needed and according to user defined preferences. The user-profile module 100 could place such orders through the use of an external device, when connected. Such a connection could be a physical connection, or it could be a wireless connection. Using a wireless communication protocol such as Bluetooth™, WiFi™ and/or cellular data may be beneficial, as the module 100 could be configured to make use of such wireless connections (when available) without needing the user to interact with the module 100, as would be needed if a physical connection were to instead be used.

A connection to an external device, whether physical or wireless, could also be used by the module 100 to copy data stored in the internal computer memory 108 of the module 100 to an external device. Such an external device could be, for example, a computer or a smartphone. Alternatively, or additionally, the module 100 could copy the data to cloud storage (i.e. remote storage to be accessed via the internet). Copying the stored data to an external device would be beneficial to help minimize data loss in the event of loss or damage to the module 100.

The user-profile module 100 may be used to restrict access to an operatively connected aerosol provision device 200. The user-profile module 100 may be used to configure the operatively connected aerosol provision device 200 such that a user is required to unlock the device 200 before it may be used. For example, if the aerosol provision device 200 comprises a user interface configured to receive user input, the user-profile module 100 could configure the device 200 such that a ‘lock code’ must be entered into the user interface before the device 200 may be used. Alternatively, or additionally, the module 100 could configure the device 200 such that the module 100 must be operatively connected to the device 200 before it can be used. In another example, the module 100 could allow the user to select, in use, whether the aerosol provision device 200 should be locked or unlocked after the module 100 is disconnected; such a selection could be made using a user interface located on the module 100 or on the aerosol provision device 200. Allowing the user to secure the device 200 against unauthorized use could be beneficial in order to improve the safety of the device 200, for example by accidental activation of the device 200 and/or preventing unauthorized users (for example, children) from activating the device 200.

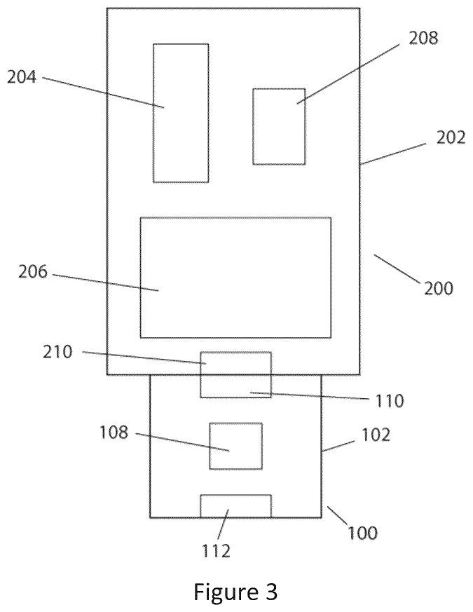

Referring to FIG. 3, a system comprising an aerosol provision device 200 and a user-profile module 100 is schematically illustrated. The connector 210 of the aerosol provision device 200 is directly connected to the first connector 110 of the module 100. In such a system, the user-profile module 100 may comprise a second connector 112 to which an additional module may be connected. The aerosol provision device 200 may comprise a second and further connectors (not shown) configured to connect to additional modules.

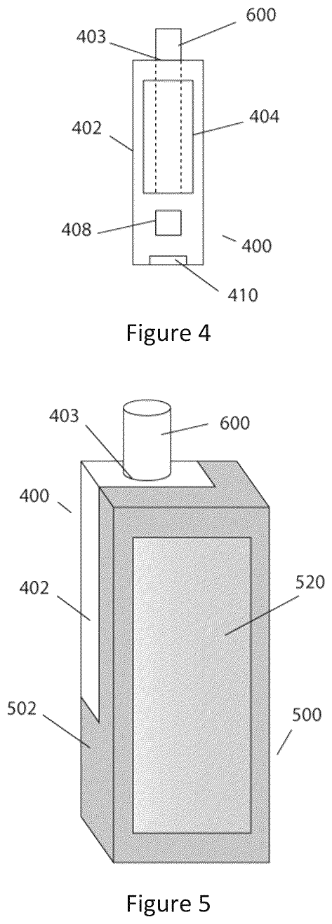

FIG. 4 illustrates a further example of an aerosol provision device 400, comprising: a housing 402; an opening in the housing 403, the opening 403 being configured to allow an article comprising aerosol-generating material 600 to be inserted into the aerosol provision device; a heater 404; internal computer memory 408; and a connector 410. As illustrated in FIG. 4, the article comprising aerosol-generating material 600 is inserted into the opening 403 and extends into the housing 402 into the heater 404. In this example, the aerosol provision device 400 does not comprise an internal power supply, and thus in use must be connected to either: a module configured to supply power to the aerosol provision device, or an external power supply.

FIG. 5 illustrates another example of a system comprising the aerosol provision device 400 and a user-profile module 500. The user-profile module 500 illustrated in FIG. 5 comprises a housing 502, and a user interface 520 located on the housing 502. In this illustrated example, the user interface 520 is a touchscreen.

In this example, the user-profile module 500 is configured such that when an operative connection is made between the first connector of the aerosol provision device 400 and the first connector of the module (not shown), the module 500 partially surrounds the aerosol provision device 400. Such an arrangement improves the strength and durability of the connection between the aerosol provision device 400 and the module 500 and provide a robust system overall. Such an arrangement also reduces the likelihood of the operative connection being accidentally broken during use, for example. Such an arrangement may also, in use, be more ergonomic than other arrangements, allowing for increased user comfort.

The aerosol provision device 400 and the module 500 illustrated in FIG. 5 are configured such that the aerosol provision device 400 may be slid into place in order to operatively connect to the module 500. In such an arrangement, the module 500 and aerosol provision device 400 may comprise means for assisting the user to properly align the two connectors; for example the housing 502 of the module 500 may comprise a guiding groove into which a protrusion located on the housing 402 of the module 400 may be slid in order to properly align the first connector 410 of the aerosol provision device and the first connector 510 of the module 500.

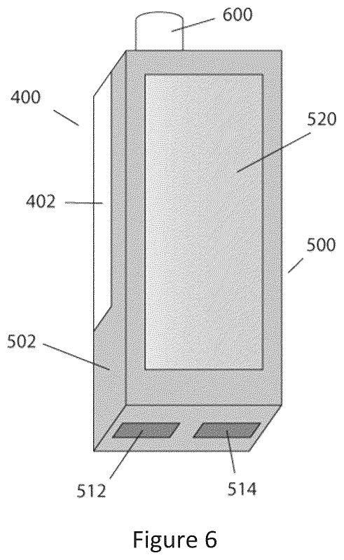

FIG. 6 shows an alternative view of the example illustrated in FIG. 5. In the example shown in FIG. 6, the user-profile module 500 is shown to comprise two connectors 512 and 514, in addition to the first connector (not shown) that is connected to the aerosol provision device 400. As discussed previously, the user-profile module may comprise a second or further connectors configured to connect to additional modules. Such additional modules may, in use, provide the operatively connected aerosol provision device 400 with additional functionality. For example, an additional module comprising an internal power supply could be connected to one of the additional connectors (512 or 514), thereby to provide the system with additional electrical power. Alternatively, or additionally, in an example where the user-profile module 500 does not comprise a touch screen, a module comprising an enhanced user interface (such as a touch screen) could be connected to one of the additional connectors.

The above embodiments are to be understood as illustrative examples of the disclosure. Further embodiments of the disclosureff are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A user-profile module for use with an aerosol provision device, the user-profile module comprising:
a housing;
an internal computer memory located within the housing; and
a connector for operatively connecting the user-profile module to the aerosol provision device;
the user-profile module being for storing one or more user profiles in the internal computer memory, wherein each user profile comprises user profile data; and
the user-profile module being configured to, in use, perform at least one of:
copying user profile data from the one or more user profiles stored in the internal computer memory to the aerosol provision device, or
controlling at least one function of the aerosol provision device in dependence upon the one or more user profiles.

2. The user profile module according to claim 1, wherein the user profile data consists of at least one of one or more user preferences or usage information.

3. The user-profile module according to claim 1, wherein the user-profile module is configured such that, in use, the user-profile module is able to configure an operatively connected aerosol provision device with one or more user preferences as defined in the one or more user profiles.

4. The user-profile module according to claim 1, wherein the user-profile module is configured such that, in use, the user-profile module is able to copy user profile data from the aerosol provision device, the user profile data copied being stored in one or more user profiles stored in the internal computer memory of the user-profile module.

5. The user-profile module according to claim 1, wherein, in use, the user-profile module is configured to identify one or more properties of an operatively connected aerosol provision device.

6. The user-profile module according to claim 5, wherein, in use, the user-profile module is configured to selectively transfer user profile data between the user-profile module and the aerosol provision device, based on the identified properties of the operatively connected aerosol provision device.

7. The user-profile module according to claim 1, wherein the internal computer memory is non-volatile computer memory.

8. The user-profile module according to claim 1, wherein the user-profile module contains an internal power supply.

9. The user-profile module according to claim 8, wherein the internal power supply is a rechargeable battery or a capacitor.

10. The user-profile module according to claim 8, wherein the user-profile module is configured to supply electrical power to an operatively connected aerosol provision device.

11. The user-profile module according to claim 1, wherein the user-profile module is configured to wirelessly transfer electrical power.

12. The user-profile module according to claim 1, further comprising a user interface.

13. The user-profile module according to claim 12, wherein the user interface is configured to do at least one of: provide the user with information, or receive input from the user.

14. The user-profile module according to claim 12, wherein, in use, the user interface allows a user to interact with at least one of the user-profile module or an operatively connected aerosol provision device.

15. The user-profile module according to claim 1, wherein the user-profile module is configured to communicate with an external device.

16. The user-profile module according to claim 15, wherein the user-profile module is configured to communicate with the external device using one or more of the following wireless communication protocols: Bluetooth™; Wi-Fi™; or cellular network communication.

17. An aerosol provision device comprising:
a housing;
an aerosol generator located within the housing;
a power supply for powering the aerosol provision device; and
a connector for releasably connecting the aerosol provision device to a user-profile module;
wherein, in use, when the aerosol provision device is operatively connected to the user-profile module, functionality that is unavailable when the aerosol provision device is operatively disconnected from the user-profile module is activated in response to input received from the user-profile module.

18. A system comprising an aerosol provision device and the user-profile module according to claim 1, wherein the user-profile module is operatively connected to the aerosol provision device, the operative connection being either:
a direct connection to a connector of the aerosol provision device; or
a connection to one or more other modules, wherein at least one of the one or more other modules is directly connected to a connector of the aerosol provision device,
wherein, in use, the operatively connected user-profile module performs at least one of:
copying the user profile data from the one or more user profiles stored in the internal computer memory of the user-profile module to the aerosol provision device; or
controlling at least one function of the aerosol provision device in dependence upon the one or more user profiles.
